(19) United States
(12) Patent Application Publication
(10) Pub. No.: US 2023/0240804 A1
(43) Pub. Date: Aug. 3, 2023

(54) ORTHODONTIC APPLIANCE

(71) Applicant: 1092228 B.C. Ltd, Anmore (CA)

(72) Inventor: Zhi Chun Song, Anmore (CA)

(21) Appl. No.: 17/812,446

(22) Filed: Jul. 14, 2022

Related U.S. Application Data
(63) Continuation-in-part of application No. 17/808,545, filed on Jun. 24, 2022.

(30) Foreign Application Priority Data
Jan. 31, 2022 (WO) PCT/CA2022/050135

(51) Int. Cl. A61C 7/08

(52) U.S. Cl. CPC A61C 7/08

(57) ABSTRACT

This invention is related to an orthodontic appliance for repositioning teeth, the orthodontic appliance comprises an aligner having cavities dimensioned to receive the teeth, and the teeth comprise a repositionable tooth arranged to be repositioned by the aligner; and the orthodontic appliance comprises an aligner bulge over an unoccupied space formed at a tooth surface of a tooth of the teeth when the aligner is fully installed, and the tooth is next to the repositionable tooth.

### CROSS-REFERENCE TO RELATED APPLICATIONS

The present application claims priority to PCT patent application PCT/CA2022050135 filed on Jan. 31, 2022 and US17/808,545 filed Jun. 24, 2022

### FIELD OF INVENTION

The present invention relates generally to the field of orthodontics, and more particularly to dental repositioning appliances having improved or optimized geometries incorporating one or more shaped features or bulges.

### DESCRIPTION OF RELATED ART

An objective of orthodontics is to move a patient's teeth to positions where function and/or aesthetics are optimized. Traditionally, appliances such as braces are applied to a patient's teeth by an orthodontist or dentist and the set of braces exerts continual force on the teeth and gradually urges them toward their intended positions. Over time and with a series of clinical visits and adjustments to the braces, the orthodontist adjusts the appliances to move the teeth toward their destination.

Now alternatives to conventional orthodontic treatment with traditional affixed appliances have become available. For example, systems including a series of preformed aligners have become commercially available from many companies. The design of the aligners can rely on computer modeling of a series of planned successive tooth arrangements, and the individual aligners are designed to be worn over the teeth and elastically reposition the teeth to each of the planned tooth arrangements.

For aligners used to reposition a tooth from the original tooth arrangement to the next tooth arrangement, each aligner is formed according to the next desired tooth arrangement and all the teeth remain in the original tooth arrangement before the aligner is installed. The discrepancy in the positions of the repositionable tooth between the original and the next tooth arrangements causes the aligner to deform when a new aligner is fully installed for the first time. This aligner deformation mainly takes place at the aligner part around the repositionable tooth and next to the repositionable tooth, where the positional discrepancy is greatest. The deformation of the aligner generates orthodontic forces to cause tooth repositioning. Sometimes this deformation may also cause aligner displacement, for example with severely twisted teeth, and this displacement may cause the teeth to be unable to move to the next tooth arrangement. Sometimes severe displacement may cause the aligner to not function. Some improvement needs to be made to solve this problem.

### SUMMARY OF THE INVENTION

To prevent aligner displacement from its fully installed position on the dental arch and to make the orthodontic force generated by the aligner gentler and more long-lasting, the present invention provides novel design on the aligner.

One general aspect includes an orthodontic appliance for repositioning teeth. The orthodontic appliance comprises an aligner having cavities arranged to receive the teeth, and one or more attachments are attached on the teeth, and the teeth comprise a repositionable tooth arranged to be repositioned by the aligner; and part of the aligner is spaced away from a surface of the teeth when the aligner is fully installed, such that the orthodontic appliance comprises an aligner bulge formed at a tooth next to the repositionable teeth.

Implementations may include one or more the following features. A height of the aligner bulge may be less than 1.5 mm. The aligner bulge may be formed over one of the attachments, and wherein the aligner has no contact with that attachment. The aligner bulge is formed next to one of the attachments, and wherein the aligner has contact with that attachment only at a distal surface of that attachment. The aligner bulge covers a surface of a tooth such that the aligner has no contact with the surface of the tooth. The aligner bulge may cover part of a tooth surface of a tooth. The aligner bulge is next to the repositionable teeth. An attachment is attached on the tooth surface, and wherein the aligner has force engagement with the attachment. The most prominent part of the aligner over the tooth surface is touching a distal surface of the attachment. The aligner is designed to contact the tooth surface only at a most prominent part of the tooth surface. The most prominent part of the aligner over the tooth surface is touching the most prominent part of the tooth surface. The aligner bulge extends to cover a part of a tooth surface of the repositionable tooth. The aligner bulge may cover buccal, lingual, and occlusal surfaces of a tooth, the aligner being designed to contact these surfaces of the tooth only at the most prominent parts of these surfaces.

The foregoing summary is illustrative only and is not intended to be in a way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

Various objects, features and advantages of the invention will be apparent from the following description of embodiments of the invention, as illustrated in the accompanying drawings. The drawings are not necessarily to scale, emphasis instead being placed upon illustrating the principles of various embodiments of the invention.

FIG. 1 is a horizontal sectional view of part of a dental arch with an aligner fully installed according to a first embodiment, showing an aligner bulge applied at a tooth next to a repositionable tooth;

FIG. 2 is a horizontal sectional view of part of a dental arch with an aligner fully installed according to a second embodiment, showing an aligner bulge applied over a tooth next to a repositionable tooth;

FIG. 3 is a horizontal sectional view of part of a dental arch with an aligner fully installed according to a third embodiment, showing the aligner bulge applied between an attachment and a repositionable tooth;

FIG. 4 is a horizontal sectional view of part of a dental arch with an aligner fully installed, showing a variation of the third embodiment;

FIG. 5 is a horizontal sectional view of part of a dental arch with an aligner fully installed according to a fourth embodiment, showing an aligner bulge formed at a tooth next to a repositionable tooth;

FIG. 6 is a horizontal sectional view of part of a dental arch with an aligner fully installed, showing a variation of the fourth embodiment;

Dotted lines represent the teeth fitted into the aligner. Only part of an aligner is shown in each figure.

### DETAILED DESCRIPTION OF PREFERRED EMBODIMENTS

An aligner is used to reposition teeth from one tooth arrangement to the next tooth arrangement, whereby the aligner is formed according to the next tooth arrangement and a repositionable tooth of the teeth remains at the one tooth arrangement before the aligner is fully installed. The discrepancy of the positions of the repositionable tooth between the one and the next tooth arrangements causes the aligner to deform when the aligner is fully installed for the first time. This aligner deformation mainly take place at a part of the aligner around the repositionable tooth and next to the repositionable tooth, where the positional discrepancy is greatest. The deformation of the aligner generates orthodontic forces to cause tooth repositioning. When the teeth malocclusion is severe this deformation may also cause aligner displacement, and severe displacement may cause the aligner out of function, for example a severely twisted tooth.

If a part of the aligner next to the repositionable tooth has been made more flexible, such that the deformation would mainly happen at this part of the aligner. The orthodontic force generated by the aligner deformation may become gentler and long-lasting. Having part of the aligner spaced away from a tooth surface of a tooth creates an aligner bulge over an unoccupied space when the aligner is fully installed, this aligner bulge is applied at a tooth next to a repositionable tooth which is programmed to be repositioned. This innovative idea makes the part of the aligner more flexible, and the aligner displacement is less likely to happen. An unoccupied space is always formed between an aligner bulge and a tooth surface when an aligner is fully installed and the unoccupied space is designed to have a definitive shape and has an unoccupied volume of space. A repositionable tooth is a tooth which is programmed to be repositioned by an associated aligner in this application, an anchor tooth is a tooth which is programmed to be as an anchor and keep its position unchanged.

To keep an anchor tooth in place an aligner needs to have at least one contact point with a distal surface of the anchor tooth. A distal surface of the teeth in a dental arch refers to an occlusal surface of posterior teeth and an incisal edge of anterior teeth. A side surface of a tooth includes a buccal surface, a lingual surface, a mesial surface and a distal surface of the tooth. The aligner may be spaced away from a tooth surface of the anchor tooth and keep the anchor tooth in position when the aligner is fully installed.

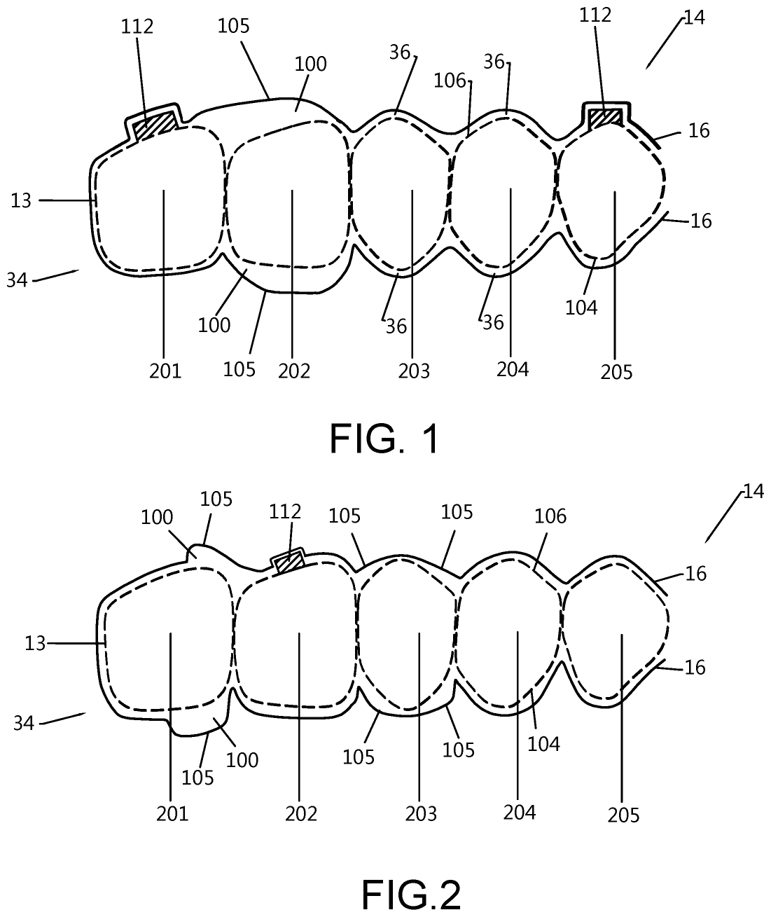

FIG. 1 is a horizontal cross section view of part of a dental arch 14 with an aligner 16 fully installed 34. The second molar 201 is a repositionable tooth arranged to be repositioned. An attachment 112 is cemented on a buccal surface 106 of tooth 201. Another attachment 112 is cemented on a buccal surface 106 of tooth 205. One aligner bulge 105 covers a whole buccal surface 106 of first molar 202 and the aligner has no contact with the buccal surface 106 of tooth 202, and this aligner bulge 105 also extends to cover part of the buccal surface 106 of tooth 201. Another aligner bulge 105 covers a whole lingual surface 104 of first molar 202 and the aligner 16 has no contact with the lingual surface. Unoccupied spaces 100 are formed between the aligner bulges 105 and the tooth surfaces. The aligner 16 has at least one contact point with an occlusal surface of the tooth 202. A height of the aligner bulges is preferably less than 1.5 mm.

More than one aligner bulge 105 over an unoccupied space 100 may be applied at one aligner. In an orthodontic treatment a dental arch may have more than one repositionable tooth arranged to be repositioned by an aligner.

FIG. 2 is a horizontal cross section view of part of a dental arch 14 with an aligner 16 fully installed. First molar 202 is arranged to be repositioned. An attachment 112 is applied on a buccal surface 106 of first molar 202. One aligner bulge 105 is applied at a buccal surface 106 of second molar 201 and covers part of the buccal surface 106 of second molar 201, and the aligner bulge extends to cover part of the buccal surface 106 of first molar 202. One aligner bulge is applied at a lingual surface 104 of second molar 201 and covers part of the lingual surface. The aligner bulge 105 is applied next to the repositionable tooth 202. One aligner bulge 105 is applied at a buccal surface 106 of second premolar 203 and the aligner 16 contacts the buccal surface 106 only at the most prominent part of the buccal surface 106; the aligner bulge extends to cover part of a tooth surface of the repositionable tooth 202. One aligner bulge 105 is applied at a lingual surface 104 of second premolar 203 and the aligner 16 contacts the lingual surface 104 only at the most prominent part of the lingual surface 104, and the most prominent part of the aligner 16 over the lingual surface 104 is touching the most prominent part of the lingual surface 104 when the aligner 16 is fully installed 34. All these aligner bulges 105 cover part of a tooth surface of a tooth next to the repositionable tooth 202. Unoccupied spaces 100 are formed between these aligner bulges and tooth surfaces.

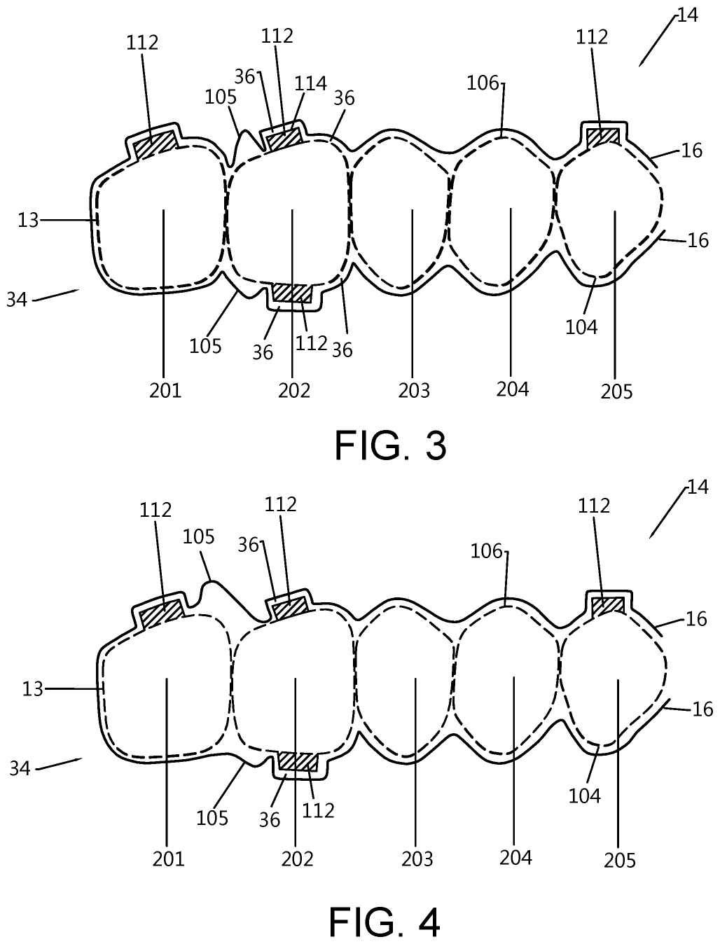

FIG. 3 is a horizontal cross section view of part of a dental arch 14 with an aligner 16 fully installed. Second molar 201 is programmed to be repositioned. One aligner bulge 105 is applied at a buccal surface 106 of first molar 202 between the repositionable tooth 201 and an attachment 112 on the buccal surface 106 of first molar 202. Another aligner bulge 105 is applied at a lingual surface 104 of first molar 202 between the repositionable tooth 201 and an attachment 112 on the lingual surface 104 of the first molar 202. The two aligner bulges 105 do not cover any part of the attachments 112, the aligner 16 has contact 36 with all the outer surfaces of the attachments 112 and has force engagement with the attachments 112. The most prominent part of the aligner 16 over the lingual surface 104 of tooth 202 is touching the distal surface 114 of the attachment 112 at the lingual surface 104. The aligner bulge 105 at the buccal surface 106 of tooth 202 is higher than a part of the aligner 16 over the attachment 112 at the buccal surface 106 of tooth 202.

FIG. 4 is a horizontal cross section view of part of a dental arch 14 with an aligner 16 fully installed, showing a variation of the embodiment shown in FIG. 3. Second molar 201 is programmed to be repositioned. One aligner bulge 105 is applied between an attachment 112 at a buccal surface 106 of the repositionable tooth 201 and an attachment 112 at a buccal surface 106 of first molar 202; the aligner bulge 105 covers part of the buccal surface 106 of tooth 202 and covers part of the buccal surface 106 of the repositionable tooth 201; the aligner 16 has good contact 36 with all the outer surfaces of the attachments 112 at the buccal surfaces 106 of the tooth 202 and tooth 201. Another aligner bulge 105 is applied at a lingual surface 104 of first molar 202 and is next to an attachment 112 on the lingual surface 104, and the aligner bulge 105 also extends to cover part of a tooth surface of the repositionable tooth 201; the aligner 16 has contact 36 with all the outer surfaces of the attachment 112 at the lingual surface of the tooth 202 and has force engagement with the attachment 112.

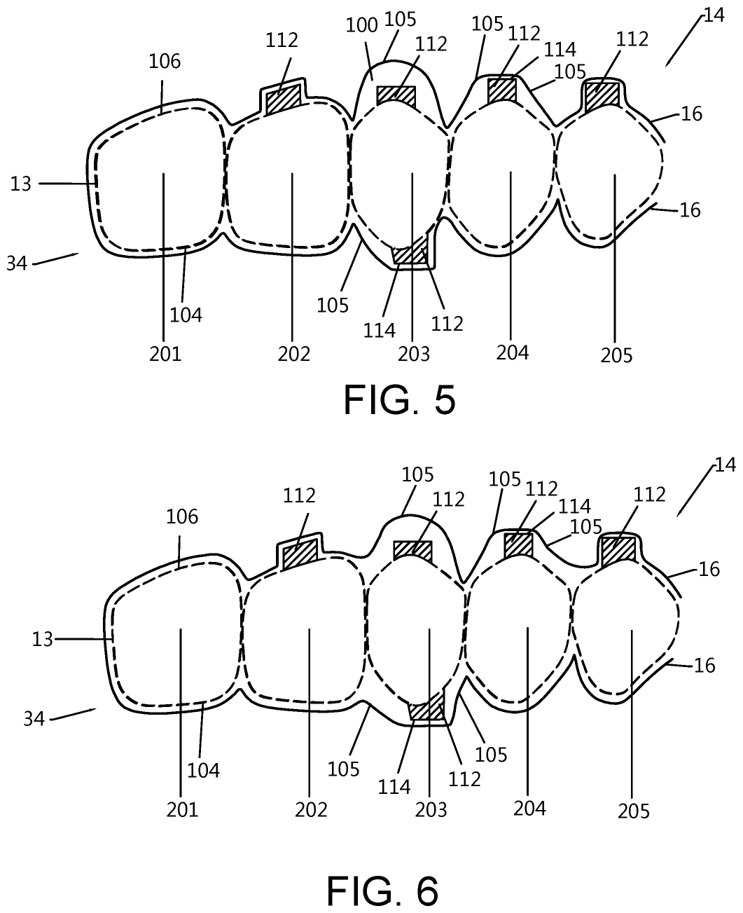

FIG. 5 is a horizontal cross section view of part of a dental arch 14 with an aligner 16 fully installed. First molar 202 is a repositionable tooth. One aligner bulge 105 is applied over an attachment 112 at a buccal surface 106 of second premolar 203 and the aligner 16 has no contact with the attachment 112; this aligner 16 has no force engagement with the attachment 112. One aligner bulge 105 is applied over a lingual surface 104 of second premolar 203 and cover part of an attachment 112 on the lingual surface 104; and the aligner 16 has contact with a distal surface 114 and a side surface of the attachment 112. One aligner bulge 105 is applied around an attachment 112 at a buccal surface 106 of first premolar 204 and the aligner 16 has contact with the attachment 112 only at a distal surface 114 of the attachment 112; the most prominent part of the aligner 16 over the buccal surface 106 of tooth 204 is touching the distal surface 114 of the attachment 112 at the buccal surface 106, this aligner 16 has no force engagement with the attachment 112. All outer surfaces of an attachment includes a distal surface and side surfaces of the attachment. Usually, an aligner 16 has force engagement with an attachment 112 covered by the aligner 16. However, by employing an aligner bulge over an attachment on a tooth next to a repositionable tooth, the aligner 16 may have no force engagement with the attachment 112, such that this part of the aligner 16 becomes more flexible and provide a gentler orthodontic force to the repositionable tooth and displacement of the aligner over the repositionable tooth is less likely to happen.

FIG. 6 is a horizontal cross section view of part of a dental arch 14 with an aligner 16 fully installed. Tooth 202 is a repositionable tooth. One aligner bulge 105 is applied over an attachment 112 at a buccal surface 106 of second premolar 203 and the aligner 16 has no contact with the attachment 112; the aligner bulge 105 extends to cover part of a tooth surface of tooth 202. One aligner bulge 105 is applied at a lingual surface 104 of second premolar 203, the aligner bulge is applied over an attachment 112 at the lingual surface 104 and the aligner 16 has contact with the attachment 112 only at a distal surface 114 of the attachment 112; the aligner bulge 105 extends to cover part of a tooth surface of tooth 202. One aligner bulge 105 is applied around an attachment 112 at a buccal surface 106 of first premolar 204 and the aligner 16 has contact with the attachment 112 only at a distal surface 114 of the attachment 112, the most prominent part of the aligner 16 over the buccal surface 106 of tooth 204 is touching the distal surface 114 of the attachment 112.

In some cases, the orthodontic appliance comprises an attachment for being attached on a tooth surface of a tooth next to the repositionable tooth, the aligner bulge covers part of the attachment; sometimes the aligner may have no force engagement with the attachment when the aligner is fully installed; sometimes the aligner may have force engagement with the attachment when the aligner is fully installed.

In some cases, the teeth covered by an aligner comprise an adjacent tooth next to a repositionable tooth and the adjacent tooth may be another repositionable tooth, and an aligner bulge may only cover part of a tooth surface of the adjacent tooth.

In some cases, an aligner bulge 105 may be applied over an occlusal surface of a tooth next to a repositionable tooth.

In some cases, an aligner bulge may be applied at two adjacent teeth next to a repositionable tooth.

In some cases, the orthodontic appliance comprises an attachment for being attached on a tooth surface of a tooth next to the repositionable tooth, the aligner bulge is applied between the attachment and the repositionable tooth; the most prominent part of the aligner over the tooth surface is touching the distal surface of the attachment.

In some cases, the orthodontic appliance comprises an attachment for being attached on a buccal surface of a tooth next to the repositionable tooth and another attachment for being attached on a buccal surface of the repositionable tooth, an aligner bulge may be applied on the buccal surfaces between these two attachments and the aligner has force engagement with these two attachments. Similar arrangement can be done on a lingual surface of these teeth also.

A height of an aligner bulge is a distance from a distal end of the aligner bulge to a tooth surface or an attachment surface which is covered by the aligner bulge. Usually, a preferred height of the aligner bulge is less than 1.5 mm, sometimes the aligner bulge may be less than 1 mm, or even less than 0.5 mm. But the aligner bulge may have a height greater than 1.5 mm.

The aligner bulge 105 mentioned in this application can be manufactured by using general known methods and technique.

The method may comprise the following steps:
(a) providing a positive model of a dentition;
(b) providing an added structure on a tooth surface of the positive model;
(c) forming the aligner over the positive model and over the added structure such that the aligner includes an aligner bulge which is applied at the added structure location.

The added structure is a non-dental structure, i.e. it does not form part of the patient's initial or final tooth arrangement in the dentition model. Instead the added structure is designed to provide a sacrificial protrusion for the subsequent aligner bulge.

Dentition modelling may use common knowledge in the field of orthodontics to obtain a digital model of a dentition of a patient using a digital scanner, such as iTero. After the repositioning treatment has been design, a plurality of modified digital dentition models can be defined by a plurality of tooth arrangements. One of the modified digital dentition models and a digital model of an added structure can be merged into a combined digital model. A positive model of the combined digital model can be printed out by a 3D printing machine using existing techniques and materials. Similarly, methods to program the aligner tooth arrangements by computer are well known.

### REFERENCE LIST

Tooth side surface 13

Dental arch 14

Aligner 16

Fully installed position 34

Contact point 36

Unoccupied space 100

Tooth lingual surface 104

Aligner bulge 105

Tooth buccal surface 106

Attachment 112

Attachment distal surface 114

Second molar 201

First molar 202

Second premolar 203

First premolar 204

Canine 205

Usage of relative terms, such as “lower, upper, inner, outer, under, over, and on top of,” are intended to simplify understanding of the apparatus when in normal use. While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

1. An orthodontic appliance for repositioning teeth, the teeth comprising a repositionable tooth to be repositioned and an adjacent tooth next to the repositionable tooth, the orthodontic appliance comprising:
an aligner having cavities dimensioned to receive the teeth, wherein part of the aligner is spaced away from a tooth surface of the adjacent tooth when the aligner is fully installed, such that at least one aligner bulge is formed at the adjacent tooth.

2. The orthodontic appliance of claim 1 further comprising an attachment for being attached on the tooth surface of the adjacent tooth, and wherein the aligner bulge is located over the whole attachment and the aligner has no contact with the attachment when the aligner is fully installed.

3. The orthodontic appliance of claim 1 further comprising an attachment for being attached on the tooth surface of the adjacent tooth, and wherein the aligner bulge is located over one part of the attachment and the aligner has contact with another part of the attachment when the aligner is fully installed.

4. The orthodontic appliance of claim 1 further comprising an attachment for being attached on the tooth surface of the adjacent tooth, and wherein the aligner bulge is located between the attachment and the repositionable tooth when the aligner is fully installed.

5. The orthodontic appliance of claim 4 wherein the aligner has force engagement with the attachment when the aligner is fully installed.

6. The orthodontic appliance of claim 4 wherein a most prominent part of the aligner over the tooth surface of the adjacent tooth is touching a distal surface of the attachment when the aligner is fully installed.

7. The orthodontic appliance of claim 1 wherein the aligner bulge covers a part of the tooth surface of the adjacent tooth when the aligner is fully installed.

8. The orthodontic appliance of claim 1 wherein the aligner bulge is next to the repositionable tooth when the aligner is fully installed.

9. The orthodontic appliance of claim 1 wherein the aligner bulge covers the whole tooth surface, and the aligner has no contact with the tooth surface of the adjacent tooth when the aligner is fully installed.

10. The orthodontic appliance of claim 7 wherein the aligner is dimensioned to contact the tooth surface of the adjacent tooth only at a most prominent part of the tooth surface when the aligner is fully installed.

11. The orthodontic appliance of claim 7 wherein the most prominent part of the aligner over the tooth surface of the adjacent tooth is touching a most prominent part of the tooth surface when the aligner is fully installed.

12. The orthodontic appliance of claim 1 wherein the aligner bulge extends to cover part of a tooth surface of the repositionable tooth when the aligner is fully installed.

13. The orthodontic appliance of claim 1 wherein a height of the aligner bulge is less than 1.5 mm.

14. The orthodontic appliance of claim 7 wherein the aligner bulge extends to cover part of a tooth surface of the repositionable tooth when the aligner is fully installed.
